(19) United States
(12) Patent Application Publication
(10) Pub. No.: US 2021/0171791 A1
(43) Pub. Date: Jun. 10, 2021

(54) INK COMPOSITION

(71) Applicant: University of Surrey, Surrey (GB)

(72) Inventors: Maxim Shkunov, Surrey (GB); Pavlos Giannakou, Surrey (GB)

(21) Appl. No.: 17/014,003

(22) Filed: Sep. 8, 2020

(30) Foreign Application Priority Data
Dec. 4, 2019 (GB) 1917739.3

(51) Int. Cl. C09D 11/38; C09D 11/033; C08K 3/22; C08K 5/053; H01G 11/86

(52) U.S. Cl. CPC C09D 11/38; C09D 11/033; C08K 3/22; B33Y 70/00; H01G 11/86; C08K 2003/2293; C08K 2201/011; C08K 5/053

(57) ABSTRACT

An ink composition providing NiO nanoparticles dispersed in a liquid medium, wherein the liquid medium provides a first solvent that has a boiling point of 150° C. or more, the boiling point being measured at a pressure of 100 kPa. A process for printing an ink composition, the process providing depositing an ink composition onto a substrate, the ink composition having NiO nanoparticles dispersed in a liquid medium; and removing at least a portion of the liquid medium from the substrate to provide a printed substrate having printed material thereon, wherein the liquid medium comprises a first solvent, the first solvent having a boiling point of 150° C. or more. The ink composition and printing process are useful for printing microelectronics.

### FIELD OF INVENTION

The present invention relates to an ink composition comprising nickel oxide nanoparticles and its applications.

### BACKGROUND OF THE INVENTION

Precise deposition of functional materials through fully solution-processed techniques has gained increasing attention in numerous fields in science and engineering, to enable low-cost, high-throughput alternative fabrication routes.

There is a desire to employ methods such as inkjet printing, aerosol jet printing, screen-printing, spray-coating, doctor blading, spin-coating and stamping.

Drop-on-demand (DOD) inkjet printing is a readily scalable and industrially mature fabrication process in which various two-dimensional (2D) or three-dimensional (3D) structures can be fabricated either on large or small scale, at the fraction of the cost of traditional production methods that require vacuum and/or high processing temperatures. The contactless, mask-free and digital nature of inkjet printing, leads to fewer processing steps and less material usage that minimizes the amount of waste produced—a paradigm shift in greener manufacturing. Consequently, inkjet printing has gained increasing attention as a precise functional material deposition and patterning technique in additive manufacturing.

However, inkjet printers require inks with particular fluid properties to jet reliably and consistently. In general, parameters such as viscosity, surface tension, specific gravity, and particle size and solid content must be tailored accordingly in order for an ink to fall within the printable regime. Moreover, dispersion stability over time, solid content agglomeration and shelf life are other parameters that become important for the commercialization of an ink.

### SUMMARY OF THE INVENTION

In one aspect of the disclosed technology, there is provided an ink composition comprising NiO nanoparticles dispersed in a liquid medium, wherein the liquid medium comprises a first solvent that has a boiling point of 150° C. or more, the boiling point being measured at a pressure of 100 kPa.

In another aspect of the disclosed technology, there is provided an ink composition comprising NiO nanoparticles dispersed in a liquid medium, the liquid medium comprising a first solvent and a second solvent, wherein the first solvent has a boiling point of 150° C. or more and the second solvent has a boiling point of 100° C. or less, the boiling points being measured at a pressure of 100 kPa.

### BRIEF DESCRIPTION OF SEVERAL VIEWS OF THE DRAWINGS

These and other features of the disclosed technology, and the advantages, are illustrated specifically in embodiments now to be described, by way of example, with reference to the accompanying diagrammatic drawings, in which:

FIGS. 1, 2 and 7 are schematic diagrams showing inkjet printing of NiO micro-supercapacitors.

FIG. 3: Comparison of IPNiO-150 and IPNiO-250 films to bulk NiO. IPNiO films showed 13-14 orders of magnitude higher electrical conductivity than bulk single crystal NiO.

FIGS. 4a-m: CV profiles of IPNiO MSCs at ultra-high scan rates ranging from 5 mV s⁻¹ up to 50 000 mV s⁻¹. (e) Phase angle versus frequency indicating the characteristic frequency at ca. 33.4 Hz, which corresponds to a time constant of 30 ms. (f) Impedance spectrum from 15 mHz up to 1 MHz with (g) magnification of the high frequency range between 100 Hz to 1 MHz, denoting the ESR of just 12.4 ohm cm⁻². (h) GCD curves obtained at 360, 1800 and 3600 mA cm′ with nearly ideal triangular shape. (i) Areal capacitance per device footprint area including inter-finger gaps (left axis) and areal specific capacitance per electrodes without inter finger gaps (right axis) as a function of the scan rate. (j) CV profiles of IPNiO MSCs scanned from 0.0 V up to 1.7 V at 50 mV s⁻¹. SMPG-EGS electrolyte remained stable up to 1.5 V without signs of gas evolution. (k) Cycling stability of IPNiO over 8000 charge-discharge cycles at 50 mV s⁻¹. (1) Leakage current measurements through a float current method. The leakage current was determined at 6 mA over a period of 18 h. (m) Volumetric capacitance per device footprint area and total thickness (left axis) and volumetric specific capacitance per electrodes without inter-finger gaps and current collector thickness (right axis) as a function of scan rate.

FIG. 5: Ragone plot comparing the performance of IPNiO MSCs, operated at 1.0 V and 1.5 V, to commercial energy storage devices and state-of-the-art inkjet-printed supercapacitors. The IPNiO MSCs exhibit superior energy density at low rates, approaching Li-Ion batteries performance, and superior power density well comparable to electrolytic capacitors, surpassing the best inkjet printed supercapacitors reported but also a few of the best microsupercapacitors known to date.

FIG. 6: Comparison of areal and volumetric capacitance of IPNiO MSCs to (a) state-of-the-art inkjet printed MSCs and (b) state-of-the-art MSCs realised through other fabrication methods. The IPNiO MSCs exhibited maximum areal and volumetric specific capacitances of 155 mF·cm⁻² and 705 F·cm⁻³ respectively, placing the devices among the top rated MSCs reported to date.

### DETAILED DESCRIPTION OF EXEMPLARY EMBODIMENTS

The disclosed ink compositions of the present technology are suitable for printing, as discussed in more detail below. The properties of low concentration solid content inks are largely governed by the properties of the solvent used to disperse the nanoparticles. The viscosity, density, surface tension and boiling point of the solvent determine the rheological properties of the ink. Generally, it is challenging to find solvents that disperse the nanoparticles well. It is even more challenging to find a solvent that falls into the printable regime. Furthermore, the ink must remain stable in time and prevent any agglomeration of the nanoparticles in the ink which can eventually clog the print head.

### Nickel (II) Oxide Nanoparticles

The NiO nanoparticles comprise nickel (II) oxide. The NiO nanoparticles are solid and insoluble in the liquid medium at standard ambient temperature and pressure (SATP, 25° C., 100 kPa). By insoluble, we mean that less than 0.001 g of the solute (i.e. nanoparticle material) is soluble in 100 ml of the solvent (i.e. the liquid medium) at SATP.

The composition may be described with reference to its solids content, such as the proportion of NiO nanoparticles. For inkjet printing, a solids content of 40 w/w % or less is useful and is considered to provide the necessary rheological properties for printing. For example, the composition may comprise 20 to 40 w/w % NiO nanoparticles, such as 25 to 35 w/w % NiO nanoparticles.

In some embodiments, the present technology provides a stable NiO ink for DOD inkjet printing applications. The formulation enables high solid fraction NiO inks of up to ˜40 w/w % to be prepared. The ink demonstrates highly stable droplet formation and ejection with no nozzle clogging and satellite droplet formation. Moreover, the ink shows very stable dispersion between the nanoparticles and the solvent, with shelf life exceeding 18 months with no signs of particle agglomeration or solvent evaporation. It is important to avoid solvent evaporation since this will change the proportions of the components in the ink. Even after a year of storage, the ink shows identical droplet formation and printing characteristics to a fresh solution. Multiple layers can be successfully printed without the subsequent layer breaking the boundaries of the preceding layers that can lead to distorted pattern dimensions. The NiO ink formulation shows no sensitivity to coffee ring or Marangoni flow effects, obtaining smooth, functional surface of the printed features. Sintering of the nanoparticle ink can take place at 150 to 200° C., which makes it fully compatible with polymeric substrates.

For screen printing, higher solids content can be employed. The ink composition can have a paste-like form. The composition may comprise 60 w/w % or more NiO particles, such as 60 to 80 w/w % NiO nanoparticles.

In some embodiments, the composition may comprise at least 1 w/w %, at least 5 w/w %, at least 10 w/w %, at least 15 w/w %, at least 20 w/w %, at least 25 w/w %, at least 30 w/w %, at least 35 w/w %, at least 40 w/w %, at least 45 w/w %, at least 50 w/w %, at least 55 w/w %, at least 60 w/w %, or at least 70 w/w % NiO nanoparticles and/or the composition may comprise 80 w/w % or less, 70 w/w % or less, 60 w/w % or less, 50 w/w % or less, 40 w/w % or less, 30 w/w % or less or 20 w/w % or less NiO nanoparticles.

The NiO nanoparticles may be described with reference to their particle size. The NiO nanoparticles have an average particle size of less than 1 μm. The NiO nanoparticles may be spherical nanoparticles. The average particle size can be determined by TEM (transmission electron microscopy).

Alternatively, the particle size may be determined by laser diffraction and may be measured using a laser diffraction machine, such as those available from Malvern Instruments Ltd, e.g. a Mastersizer 3000 machine, optionally with Hydro SV dispersion unit. The standard ISO 13320:2009 “Particle Size Analysis—Laser Diffraction Methods” may be employed.

In some embodiments, the NiO nanoparticles may have an average particle size of 300 nm or less, 200 nm or less, 100 nm or less, or 50 nm or less and/or the NiO nanoparticles may have an average particle size of 10 nm or more, 30 nm, or more, 50 nm or more, 100 nm or more or 200 nm or more. The NiO nanoparticles may have an average particle size of from 5 to 100 nm, such as 10 to 50 nm. An average particle size of 50 nm or less provides a composition suitable for inkjet printing and aerosol jet printing. Larger nanoparticles can be used for screen-printing, spray-coating, doctor blading, spin-coating and stamping.

The NiO nanoparticles may be described with reference to their specific surface area. The specific surface area may be determined using the Brunauer, Emmett and Teller method (BET method) as described in J. Am. Chem. Soc., 1938, 60, 309.

In some embodiments, the NiO nanoparticles may have a BET specific surface area of 30 m²/g or more or 50 m²/g or more, such as from 30 to 70 m²/g. In some embodiments, the NiO nanoparticles may comprise coated nanoparticles (e.g. encapsulated nanoparticles). For example, the NiO nanoparticles may be coated with a polymer such as polyvinylpyrrolidone (PVP) or polyacrylic acid. The coated nanoparticles may have an average particle size of 30 nm or less, such as 20 nm or less.

This is surprising since an ink composition may be considered to require the NiO nanoparticles in a pure form without encapsulation/coating. The inventors have determined that NiO nanoparticles encapsulated with PVP can reduce (or avoid) the need to employ a surfactant. NiO nanoparticles are available commercially, and methods for their preparation are described in the literature (e.g. Chen, Y. E.; Yu, Z. N.; Chen, Y. G.; Luo, L. Q.; Wang, X. Preparation of NiO Nanoparticles as Supercapacitor Electrode by Precipitation Using Carbon Black Powder. In 2011 International Conference on Materials for Renewable Energy & Environment; IEEE, 2011; pp 640-643).

### First Solvent

The first solvent has low volatility, as demonstrated by its boiling point of 150° C. or more. The boiling point is the standard boiling point, which is defined by IUPAC as the temperature at which boiling occurs under a pressure of one bar (100 kPa).

In some embodiments, the first solvent may have a standard boiling point of 155° C. or more, 160° C. or more, 165° C. or more, 170° C. or more, 175° C. or more, 180° C. or more, 185° C. or more or 190° C. or more and/or the first solvent may have a standard boiling point of 350° C. or less, 300° C. or less, 270° C. or less, 250° C. or less, 230° C. or less or 200° C. or less.

A low volatility solvent is employed to minimize problems associated with the use of high volatility solvents. When employing highly volatile solvents in inkjet printing, evaporation occurs rapidly at the nozzle, which can cause a build-up of material around the nozzle and interfere with jetting. This is often referred to as a “skinning” effect where a hardened film develops over the nozzle, or “crusting” which is a build-up of particles around the nozzle. Moreover, since highly volatile solvents evaporate quickly, they can promote a “coffee stain” effect on the printed samples. Coffee stain effect is the concentration of pigment (i.e. nanoparticles) at the outer edge of a droplet forming a ring instead of a homogeneous circular footprint of functional material. This can lead to defective printed tracks that are not functional. Therefore, in order to avoid “skinning” or “crusting” and “coffee stain” effects a low-volatility solvent is employed as the first solvent.

In some embodiments, the first solvent may be an organic solvent, rather than an aqueous solvent. Water has high surface tension which can lead to poor adhesion between the printed layer and the substrate, poor jetting performance of the ink and incompatibility with numerous commercial and industrial inkjet printers that are designed to operate with low surface tension inks.

In other embodiments, the first solvent may comprise an organic solvent, such as a polar organic solvent (as shown in Table 1).

TABLE 1

| | | boiling | solubility | | |
|---|---|---|---|---|---|
| | | point | in water | Dielectric | Relative |
| Solvent | formula | (° C.) | (g/100 g) | Constant ^{1, 2} | Polarity |
| Ethylene glycol | HOC₂H₄OH | 198 | Miscible | 37.7 | 0.790 |
| Diethylene glycol | (HOCH₂CH₂)₂O | 245 | Miscible | 31.7 | 0.713 |
| Methylene glycol | HOCH₂OH | 194 | Miscible | | |
| Propylene glycol | CH₃CH(OH)CH₂OH | 187 | Miscible | 32.0 | 0.722 |
| Ethylene glycol | BuOC₂H₄OH | 171 | Miscible | 5.3 | 0.602 |
| monobutyl ether | | | | | |
| 2-Ethoxyethyl | CH₃CH₂OCH₂CH₂O₂CCH₃ | 156 | 22.9 | | |
| acetate | | | | | |
| Furan-2-carbaldehyde | C₄H₃OCHO | 162 | miscible | 41.9 | |
| Propane-1,2,3-triol | OHCH₂CH₂(OH)CH₂OH | 290 | miscible | | |
| Butane-1,2,4-triol | OHCH₂CH₂(OH)C₂H₄OH | 190⁸ | miscible | | |
| 1-hexanol | C₆H₁₄O | 158 | 0.59 | | 0.559 |
| cyclohexanol | C₆H₁₂O | 161.1 | 4.2 | | 0.509 |
| 2-aminoethanol | C₂H₇NO | 170.9 | Miscible | | 0.651 |
| ethyl acetoacetate | C₆H₁₀O₃ | 180.4 | 2.9 | | 0.577 |
| 1-octanol | C₈H₁₈O | 194.4 | 0.096 | | 0.537 |
| benzyl alcohol | C₇H₈O | 205.4 | 3.5 | | 0.608 |

¹ The values in the table above were obtained from the CRC (87th edition), or Vogel's Practical Organic Chemistry (5th ed.).
² T = 20° C. unless specified otherwise.

In some embodiments, the first solvent may be selected from ethylene glycol, diethylene glycol, methylene glycol, propylene glycol, ethylene glycol monobutyl ether, 2-Ethoxyethyl acetate, furan-2-carbaldehyde, propane-1,2,3-triol, butane-1,2,4-triol, 1-hexanol, cyclohexanol, 2-aminoethanol, ethyl acetoacetate, 1-octanol, and/or benzyl alcohol.

In some embodiments, the first solvent may be selected from a monohydric alcohol (e.g. 1-hexanol, cyclohexanol, 2-aminoethanol, 1-octanol, and/or benzyl alcohol); a diol (e.g. ethylene glycol, diethylene glycol, methylene glycol, or propylene glycol); and/or a triol (such as propane-1,2,3-triol or butane-1,2,4-triol).

In some embodiments, the first solvent may comprise or consist of a diol. In some embodiments, the first solvent may comprise a glycol (an aliphatic diol), such as methylene glycol, ethylene glycol, propylene glycol, and/or diethylene glycol.

In some embodiments, the first solvent may comprise or consist of a triol, such as propane-1,2,3-triol, or butane-1,2,4-triol.

In some embodiments, the first solvent may comprise or consist of (i) ethylene glycol (ethane-1,2-diol), which has a standard boiling point of 197° C.; (ii) diethylene glycol, which has a standard boiling point of 245° C.; (iii) glycerol, which has a standard boiling point of 290° C.; (iv) propylene glycol, which has a standard boiling point of 188° C.; (v) 1-heptanol, which has a standard boiling point of 176° C.; (vi) 1-octanol, which has a standard boiling point of 194° C.; and/or (vii) 1-nonanol, which has a standard boiling point of 214° C.

### Second Solvent

The second solvent has high volatility, as demonstrated by its boiling point of 100° C. or less. The use of a low volatility solvent only can lead to problems with printing. For example, evaporation of the first solvent may prove time consuming, which is not practical for industry. This is especially important when printed layers are being built up; evaporation of a printed layer may be needed before a subsequently layer can be applied.

As such, the inventors propose the use of a high volatility solvent together with a low volatility solvent. The combination of the high and low volatility solvents accelerates evaporation of solvent after printing. The inventors investigated the use of ethylene glycol alone and the results are published in Giannakou et al. (J. Mater. Chem. A, 2019, 7, 21496, first published 9 Sep. 2019). The ink composition of the second aspect has unexpected benefits, as compared to the composition described in Giannakou et al. (2019).

In some embodiments, the second solvent may have a standard boiling point of 98° C. or less, 95° C. or less, 90° C. or less, 85° C. or less, 80° C. or less, 75° C. or less, 70° C. or less or 65° C. or less and/or the second solvent may have a standard boiling point of 30° C. or more, 35° C. or more, 40° C. or more, 45° C. or more, 50° C. or more or 60° C. or more.

In some embodiments, the second solvent may consist of or comprise an organic solvent. The second solvent may or may not comprise water. Examples of solvents are set out in Table 2 below.

TABLE 2

| | | boiling | solubility | | |
|---|---|---|---|---|---|
| | | point | in water | Dielectric | Relative |
| Solvent | formula | (° C.) | (g/100 g) | Constant ^{1, 2} | Polarity |
| Methanol | CH₄O | 64.6 | Miscible | 32.6(25) | 0.762 |
| Ethanol | CH₆O | 78.5 | Miscible | 24.6 | 0.654 |
| 1-propanol | C₃H₈O | 97 | Miscible | 20.1 | 0.617 |
| 2-propanol | C₃H₈O | 82.4 | Miscible | 18.3 | 0.546 |
| t-butanol | C₄H₁₀O | 82 | Miscible | | 0.389 |
| s-butanol | C₄H₁₀O | 99.5 | Miscible | 16.56 | 0.506 |
| Acetone | (CH₃)₂O | 56 | Miscible | 20.6 | 0.355 |
| Butan-2-one | C₄H₈O | 80 | Miscible | 18.5 | 0.327 |
| Tetrahydrofuran | C₄H₈O | 66 | Miscible | 7.6 | 0.210 |
| Methyl acetate | C₃H₆O₂ | 57 | 25 | 6.7 | 0.290 |
| Ethyl acetate | C₄H₈O₂ | 77 | 8.3 | | 0.230 |
| acetonitrile | C₂H₃N | 81.6 | Miscible | 37.5 | 0.460 |
| water | H₂O | 100 | — | 79.7 | 1 |
| dimethoxyethane | C₄H₁₀O₂ | 85 | Miscible | | 0.231 |
| (glyme) | | | | | |

¹ The values in the table above were obtained from the CRC (87th edition), or Vogel's Practical Organic Chemistry (5th ed.).
² T = 20° C. unless specified otherwise.

In some embodiments, the second solvent may comprise an organic solvent, such as a polar organic solvent. Common polar aprotic organic solvents include tetrahydrofuran (THF), ethyl acetate, acetone, and acetonitrile. Common protic organic solvents include alcohols (e.g. methanol, ethanol and propanol) and carboxylic acids (e.g. acetic acid). In some embodiments, the second solvent may comprise or consist of an alcohol, such as a primary alcohol, a secondary alcohol and/or a tertiary alcohol.

In some embodiments, the second solvent may be selected from a monohydric alcohol (e.g. methanol, ethanol, 1-propanol, 2-propanol, t-butanol, s-butanol), a ketone (e.g. acetone, butan-2-one), tetrahydrofuran, a carboxylate ester (e.g. methyl acetate or ethyl acetate), acetonitrile, and/or dimethoxyethane (glyme). In some embodiments, the second solvent may comprise methanol, ethanol, 1-propanol and/or 2-propanol. In some embodiments, the second solvent may be miscible with the first solvent.

### Liquid Medium

The liquid medium comprises the first solvent and optionally the second solvent. The second solvent has a lower boiling point than the first solvent. It will be understood that the liquid medium is liquid at SATP. The first solvent and/or the second solvent may be liquid at SATP.

In some embodiments, the liquid medium may consist of the first solvent, i.e. the liquid medium comprises 100% first solvent. Alternatively, the liquid medium comprises at least 50%, at least 60%, at least 70%, at least 80% or at least 90% first solvent and/or the liquid medium may comprise 95% or less, 90% or less, 80% or less, 70% or less or 60% or less first solvent (percentages by volume).

In some embodiments, the liquid medium may comprise or consist of the first solvent and the second solvent. The liquid medium may comprise at least 5%, at least 10%, at least 15%, at least 20%, at least 25%, at least 30%, at least 35% or at least 40% second solvent and/or the liquid medium may comprise 50% or less, 45% or less, 40% or less, 30% or less or 20% or less second solvent (percentages by volume). The inventors propose that more than 50 v/v % second solvent can cause jetting instabilities and make the ink prone to “skinning”, “crusting” and “coffee stain” effects formation.

Examples of the liquid medium are set out in Table 3 below.

TABLE 3

| First solvent (vol %) | Second solvent (vol %) |
|---|---|
| 50-100 | 0-50 |
| 55-95 | 5-45 |
| 60-90 | 10-40 |
| 70-80 | 20-30 |

### Additional Components

In some embodiments, the composition may comprise further components in addition to the first solvent, the optional second solvent, and the NiO nanoparticles. Such additional components may function as surfactants, wetting agents and/or adhesion promotors. In some embodiments, the composition may comprise a surfactant to homogeneously disperse the NiO nanoparticles in the liquid medium.

In some embodiments, the composition may comprise 30 w/w % or less, 25 w/w % or less, 20 w/w % or less, 15 w/w % or less, 10 w/w % or less or 5 w/w % or less surfactant and/or the composition may comprise at least 1 w/w %, at least 5 w/w % or at least 10 w/w % surfactant. In some embodiments, the surfactant may be a non-ionic surfactant.

Suitable non-ionic surfactants include those based on a hydrophilic polyethylene oxide chain and an aromatic hydrocarbon group, such as (C₁₄H₂₂O(C₂H_{4O})ₙ where n is 9.5 on average, CAS 9002-93-1, which is marketed under the trade name TRITON® X-100).

Seven different surfactant molecules were investigated to assist in dispersing the NiO nanoparticles in ethylene glycol/methanol. The results showed that TRITON® X-100 produces the most homogeneously dispersed solution with shelf life of over 18 months.

A wetting agent enhances the wetting of the ink on a variety of substrates, leading to greater adhesion. This modification is key for flexible applications where the printed patterns are subjected to extensive deformation and are prone to delamination.

An adhesion promotor enhances the mechanical integrity of the printed ink composition. An adhesion promoter may be a polymer which can increase the surface tension of the ink. As such, the amount of adhesion promotor should be controlled.

In some embodiments, the additional components may comprise P-tert-octylphenoxy polyethoxyethyl alcohol and/or polyethylene glycol, both of which are present in KODAK® Photo-Flo 200. It will be understood that a wetting agent may be viewed as a particular type of surfactant. As such, the quantity of wetting agent may contribute towards the total proportion of surfactant. Polyethylene glycol (PEG) has the H—(O—CH₂—CH₂)ₙ—OH where the n value determines its molecular weight, and includes PEG 400 a low molecular weight grade.

### Ink Composition

Example ink compositions are set out in Table 4 below (w/w %).

TABLE 4

| NiO | | | |
|---|---|---|---|
| nanoparticles | First solvent | Second solvent | Surfactant |
| 3-50 | 25-60 | 0-30 | 0-30 |
| 20-40 | 20-40 | 5-15 | 10-25 |
| 3-10 | 40-60 | 10-30 | 10-25 |
| 45-55 | 15-30 | 0-10 | 5-20 |
| 30-40 | 15-30 | 10-25 | 15-25 |
| 60-80 | 15-25 | 3-15 | 0-10 |

According to a third aspect of the disclosed technology, there is provided a process for printing an ink composition including the compositions of the first and second aspects, the process comprising depositing an ink composition onto a substrate, the ink composition comprising NiO nanoparticles dispersed in a liquid medium; and removing at least a portion of the liquid medium from the substrate to provide a printed substrate having printed material thereon, wherein the liquid medium comprises a first solvent, the first solvent having a boiling point of 150° C. or more.

The comments in relation to the ink compositions of the first and second aspects also apply to the method of third aspect. In particular, the liquid medium may additionally comprise a second solvent, the second solvent having a boiling point of 100° C. or less, the boiling point being measured at a pressure of 100 kPa.

### Depositing

Depositing may comprise inkjet printing, aerosol jet printing, screen-printing, spray-coating, doctor blading, spin-coating and stamping.

### Substrate

In some embodiments, the substrate may be made from any suitable material including polymers, such as PVA (poly(vinyl acetate)) and PET (polyethylene terephthalate). The substrate may be flexible, stretchable and/or wearable. PVA has the advantage that is can be dissolved in water to free the printed material from the substrate. This can be useful for conformal electronics.

The substrate may be coated, for example, the substrate may be coated with a sacrificial layer such as silicone. The inventors have determined that the application of a sacrificial layer, such as a silicone layer provides benefits, especially in combination with a PVA substrate. In particular, when fabricating printed electronics, such as conformal electronics, electrode cracking can be minimized by the application of a silicone layer before deposition of the ink composition.

### Removing the Liquid Medium

In some embodiments, at least a portion of the liquid medium is removed from the substrate to provide a printed substrate having printed material thereon. Typically, substantially all of the liquid medium is removed. In some embodiments, the liquid medium may be removed by evaporation to yield the printed substrate.

### Printed Electronics

The disclosed method may be employed to produce printed electronics, such as a micro-supercapacitor. NiO can be employed as a pseudocapacitative electrode. The conductivity of NiO increases dramatically when the material is prepared in the form of consolidated nanoparticles, due to defect-mediated increase of surface p-type conduction resulting from additional acceptor-like states generated by Ni²⁺ vacancies on the surface of the nanoparticles.

In some embodiments, the disclosed method may comprise an additional step of depositing (e.g. inkjet printing) a current collector. The current collector may be a metal current collector, such as a silver current collector. The current collector may be deposited onto the substrate prior to depositing the NiO nanoparticle ink. The NiO nanoparticle ink composition may be directly deposited onto the current collector.

In some embodiments, the disclosed method may comprise an additional step of removing the printed material (e.g. NiO electrodes) from the substrate. The printed material may be removed from the substrate before an annealing step. For example, a water-transfer technique in which the substrate is dissolved.

In some embodiments, the disclosed method may comprise an additional step of annealing or thermally sintering the printed material, e.g. printed electrodes. Annealing may comprise the application of heat for a fixed period. For example, the printed material may be annealed at a temperature of from 150° C. to 250° C. for a period of at least 1 hour, such as 3 to 10 hours. A novel approach has been developed to minimize the contact resistance between the individual layers by inkjet printing the NiO nanoparticle layers on top of current collector layers while unsintered. Subsequently, a sintering process is conducted where the two materials are adhered at the interface, free from defects and voids.

In some embodiments, the disclosed method may comprise an additional step of applying an electrolyte. Suitable electrolytes include LiOH, KOH, NaOH, KCl, NaNO₃, NaClO₄, Mg(ClO₄)₂ and combinations thereof. The inventors tested many combinations and the best results terms of capacitance and high scan rate retention, were obtained with magnesium Mg(ClO₄)₂. In particular, a saturated aqueous solution of magnesium perchlorate (SMP).

In some embodiments, the electrolyte may be applied by drop casting. In some embodiments, the electrolyte may be described as a UV curable electrolyte, whereby the electrolyte is applied together with a UV curable polymer.

In some embodiments, the process may comprise fabrication of a supercapacitor by inkjet printing of a current collector; inkjet printing NiO electrodes onto the current collector; thermally sintering the current collector and the NiO electrodes; and dropcasting an electrolyte.

The disclosed technology also resides in products producible by the process of the third aspect. In some embodiments, the products include printed electronics, such as a micro-supercapacitor component. In some embodiments, the product may be wearable, e.g. epidermal energy storage.

### EXAMPLES

The present invention will be further described in the following examples, which should be viewed as being illustrative and should not be construed to narrow the scope of the disclosed technology or limit the scope to any particular embodiments.

### NiO Nanoparticle Ink Formulation (Ethylene Glycol)

In this study, ethylene glycol was chosen as the first solvent for the ink, due to its suitable rheological properties for stable printing:

TABLE 5

| Temperature (° C.) | 20 | 30 | 40 | 50 | 60 | 70 |
|---|---|---|---|---|---|---|
| Viscosity, η (Pa · s) | 0.019 | 0.015 | 0.012 | 0.009 | 0.005 | 0.002 |
| Surface Tension, γ (N · m⁻¹) | 0.048 | 0.047 | 0.046 | 0.046 | 0.045 | 0.044 |
| Reynolds Number, Re = ραν/η | 6.905 | 8.419 | 10.784 | 14.997 | 24.611 | 68.570 |
| Weber Number, We = ραν²/γ | 13.459 | 13.650 | 13.846 | 14.048 | 14.257 | 14.471 |
| Ohnesorge number, Oh = (√We)/Re | 0.53 | 0.44 | 0.35 | 0.25 | 0.15 | 0.06 |
| Z Number | 1.88 | 2.28 | 2.90 | 4.00 | 6.52 | 18.03 |

NiO spherical nanoparticles (99.8%, <50 nm particle size, specific surface area of >50 m² g⁻¹) were purchased from Sigma-Aldrich (Merck) (product number: 637130). The nanoparticles were dispersed with the help of TRITON® X-100 surfactant. TRITON® X-100 (1.2 mL) was added in ethylene glycol (3 mL) followed by NiO nanoparticles (2.4 g, ca. 34 w/w %). The solution was then sonicated with a Cole Palmer CPX750 (750 W), equipped with a straight-tipped 8 mm diameter horn at 20% power (150 W) in pulses of one second ON and two seconds OFF for half an hour. The ink was then centrifuged for 45 min at 1250 RPM using an Accuspin 400 centrifuge with plastic micro-centrifuge tubes (1 mL).

The supernatant was carefully collected with a pipette and further filtered with a pore size hydrophilic polyethersulfone syringe filter (0.22 mm) to remove any particles larger than one hundredth the diameter of the print head nozzle (23 mm).

### NiO Nanoparticle Ink Formulation (Ethylene Glycol+High Volatility Solvent)

The inventors have further improved the ink composition described in Giannakou et al. (J. Mater. Chem. A, 2019, 7, 21496-21506). The table above (Table 5) shows the calculated Ohnesorge (Oh) and Z number for ethylene glycol at a temperature range that the Dimatix DMP 2800 print head (one of the most common materials inkjet printer) is capable of reaching. The properties of low solid content inks (˜<35 w/w %) are largely governed by the properties of the solvent used to disperse the nanoparticles.

A first model requires a Z-range (1<Z<10), such that ethylene glycol is a stable printable solvent from 20° C. to 60° C. a second model requires a Z-range (4<Z<14). As such, the viscosity of the solvent is too high up to 50° C., which is expected to lead to drop ejection failure. The viscosity becomes too low above 70° C., which is expected to form unwanted satellite droplets. However, for the range between 50° C. to 65° C., the Z number falls within the required region for stable printing according to both models.

The characteristic dimension a, was based on a Dimatix 10 pL cartridge print head which corresponds to 23 μm orifice. The average travelling speed of the droplet, v was taken as 5 m/s, which is the recommended ejection velocity by Fujifilm. The terms ρ corresponds to the ink density, taken as 1.11 g. cm⁻³. Including the second solvent (e.g. methanol) provides faster evaporation of the ink, and facilitates a lowering of the viscosity and surface tension of the ink so that lower temperatures (25<T<40° C.) are required to achieve ideal printing conditions. With this new modification, the ink can be used with a broader range of inkjet printers.

The broad changes are set out below:

TABLE 6

| | | |
|---|---|---|
| | Giannakou et al (2019) | |
| First solvent | Ethylene Glycol | Ethylene Glycol |
| Second solvent | N/A | Methanol/ethanol/propanol |
| Surfactant | TRITON ® X-100 | TRITON ® X-100 OR |
| | | No surfactant for NiO |
| | | Nanoparticles encapsulated |
| | | with Polyvinylpyrrolidone |
| | | (PVP) |
| Type of | Non-coated NiO, ≤50 | Non-coated NiO, ≤50 nm |
| Nanoparticles | nm spherical particles | spherical particles |
| | (Sigma-Aldrich | (Sigma-Aldrich (Merck) OR |
| | (Merck)) | 1-2 wt % PVP-coated NiO |
| | | particles, (nearly |
| | | spherical, average particle |
| | | size 18 nm, US Research |
| | | Nanomaterials, Inc) |
| Solid Content | 34 w/w % | 2-80 w/w % |
| (Concentration of | | |
| Nanoparticles) | | |
| Wetting Agent | N/A | KODAK ® Photo-Flo 200 |
| | | Wetting Agent |
| Adhesion Promoters | N/A | Polyethylene Glycol |

In general, the formulation starts by mixing the first solvent (ethylene glycol) with the second solvent (e.g. methanol). The ratio (v/v) can vary from 1:0 to 1:1. Subsequently, the surfactant (TRITON® X-100) is added to the base solvent and stirred until they are thoroughly mixed. The surfactants to solvent ratio (v/v) can vary from 1:3 to 2:3 depending on the application of the ink (high concentration inks i.e. 80 w/w % will need more surfactant i.e. 2:3 ratio) or the surfactant to nanoparticle ratio (w/w) can vary from 1:3 to 1:1. At least one of these conditions should be met to obtain a stable dispersion. Low concentration inks i.e. 10 w/w % will need less surfactant (i.e. 1:3). If PVP-encapsulated nanoparticles are to be used, the step of adding surfactant can be skipped. Subsequently, the NiO nanoparticles are added in the solution. The amount of NiO nanoparticles depends on the application. With this formulation, high concentrations up to 80 w/w % can be achieved. The ink is stirred vigorously for several minutes until the nanoparticles are evenly dispersed in solution. The ink is then sonicated with an Ultrasonic Cell Disruptor Homogenizer at a power of ˜30 W per 1 ml of ink in pulses of one second ON and two seconds OFF for half an hour. The ink is centrifuged for 45 to 60 min at 1000 RPM. The supernatant is carefully collected and further filtered with a hydrophilic polyethersulfone filter to remove any particles larger than one hundredth the diameter of the print head nozzle. For example, if the diameter of the print head nozzle is 50 μm, the pore size of the filter should be 0.50 μm. Finally, the wetting agent (Kodak Photo-Flo 200) and adhesion promoter (Polyethylene Glycol 400) are added in the ink and stirred vigorously. The ink is degassed by exposing it in vacuum.

A wide range of formulations were investigated including those set out below.

### Nanoparticle Concentration

TABLE 7

| | Ex. 1 | | Ex. 2 | | Ex. 3 | |
|---|---|---|---|---|---|---|
| | Mass | | Mass | | Mass | |
| | (g) | w/w % | (g) | w/w % | (g) | w/w % |
| NiO | 3.2500 | 31.3 | 0.3000 | 4.6 | 8.0000 | 50.1 |
| Nanoparticles | | | | | | |
| Ethylene | 3.3300 | 32.1 | 3.3300 | 50.7 | 3.3300 | 20.8 |
| Glycol | | | | | | |
| Surfactant | 1.9260 | 18.6 | 1.0700 | 16.3 | 2.7820 | 17.4 |
| Methanol | 0.7920 | 7.6 | 0.7920 | 12.1 | 0.7920 | 5.0 |
| Wetting agent | 0.5140 | 5.0 | 0.5140 | 7.8 | 0.5140 | 3.2 |
| Adhesion | 0.5650 | 5.4 | 0.5650 | 8.6 | 0.5650 | 3.5 |
| promotor | | | | | | |

Example 1 is a medium to high nanoparticle concentration with an ethylene glycol to methanol ratio (v/v) of 10:22 and an ethylene Glycol to nanoparticle ratio (w/w) of 10:17. Example 2 is a low nanoparticle concentration with a surfactant to total solvent ratio (v/v) of 1:4 and a surfactant to nanoparticle ratio (w/w) of 10:3. Example 3 is high nanoparticle concentration with a surfactant to total solvent ratio (v/v) of 2:3 and a surfactant to nanoparticle ratio (w/w) of 10:29.

### First: Second Solvent Ratio

TABLE 8

| | Ex. 4 | | Ex. 5 | |
|---|---|---|---|---|
| | Mass (g) | w/w % | Mass (g) | w/w % |
| NiO Nanoparticles | 3.2500 | 33.9 | 3.2500 | 32.3 |
| Ethylene Glycol | 3.3300 | 34.7 | 2.2200 | 22.1 |
| Surfactant | 1.9260 | 20.1 | 1.9260 | 19.1 |
| Methanol | 0.0000 | 0.0 | 1.5840 | 15.7 |
| Kodac PhotoFlo | 0.5140 | 5.4 | 0.5140 | 5.1 |
| Polyethylene Glycol | 0.5650 | 5.9 | 0.5650 | 5.6 |

Examples 4 and 5 have an ethylene glycol to methanol volume ratio of 1:0 and 1:1 respectively. Both compositions were successful for inkjet printing, there was no clogging of the printer. Moreover Example 5 has the added benefit of not needing heating to achieve the required properties for printing.

### Additional Components

TABLE 9

| | Ex. 6 | | Ex. 7 | | Ex. 8 | |
|---|---|---|---|---|---|---|
| | Mass | | Mass | | Mass | |
| | (g) | w/w % | (g) | w/w % | (g) | w/w % |
| NiO | 3.2500 | 33.9 | 3.2500 | 31.3 | 3.2500 | 31.3 |
| Nanoparticles | | | | | | |
| Ethylene | 3.3300 | 34.7 | 3.3300 | 32.1 | 3.3300 | 32.1 |
| Glycol | | | | | | |
| Surfactant | 1.9260 | 20.1 | 1.9260 | 18.6 | 1.9260 | 18.6 |
| Methanol | 0.0000 | 0.0 | 0.7920 | 7.6 | 0.7920 | 7.6 |
| Wetting agent | 0.5140 | 5.4 | 0.5140 | 5.0 | 0.5140 | 5.0 |
| Adhesion | 0.5650 | 5.9 | 0.5650 | 5.4 | 0.5650 | 5.4 |
| promotor | | | | | | |

### Coating

TABLE 10

| | Ex. 9 | | Ex. 10 | | Ex. 11 | |
|---|---|---|---|---|---|---|
| | Mass | | Mass | | Mass | |
| | (g) | w/w % | (g) | w/w % | (g) | w/w % |
| NiO | 3.2500 | 32.0 | 0.5000 | 4.8 | 13.0000 | 65.9 |
| Nanoparticles | | | | | | |
| Ethylene | 4.3290 | 42.6 | 4.3290 | 41.7 | 4.2180 | 21.4 |
| Glycol | | | | | | |
| Methanol | 1.5048 | 14.8 | 1.5048 | 20.3 | 1.4256 | 7.2 |
| Kodac | 0.5140 | 5.1 | 0.5140 | 6.9 | 0.5140 | 2.6 |
| PhotoFlo | | | | | | |
| Polyethylene | 0.5650 | 5.6 | 0.5650 | 7.6 | 0.5650 | 2.9 |
| Glycol | | | | | | |

Example 9 has a medium to high nanoparticle concentration. Example 10 has a low nanoparticle concentration. Example 11 has a very high nanoparticle concentration. However, only very little sedimentation occurred so the inventors submit that the formulation can be extended to 70-80 w/w % concentration.

### SMPG-EGS Electrolyte Preparation

In this study, a saturated magnesium perchlorate aqueous solution (SMPAS) was prepared by mixing magnesium perchlorate salt (hexahydrate, 99%, Alfa Aesar, product number: 11635) with deionised water under vigorous stirring at 40° C. until the solution was saturated. The gel electrolyte was prepared by mixing SMPAS (4 mL) with PVA (120 mg, M_{w} 89000-98000, +99% hydrolysed, Sigma-Aldrich (Merck), product number: 341584) and heating up to 80° C. for 30 min under vigorous stirring, followed by the addition of ethylene glycol (300 μL) and Kodak PhotoFlo 200 (160 μL) wetting agent. PVA served as the polymer host of the gel electrolyte. Ethylene glycol was added due to its hygroscopic property which helps to retain water in the electrolyte and prevent crystallization of the salt. Kodak Photo-Flo 200 was added to lower the surface tension of the electrolyte to ensure thorough wetting of the pores of NiO films.

### Fabrication of Inkjet Printed NiO Micro-Supercapacitors (IPNiO MSCs)

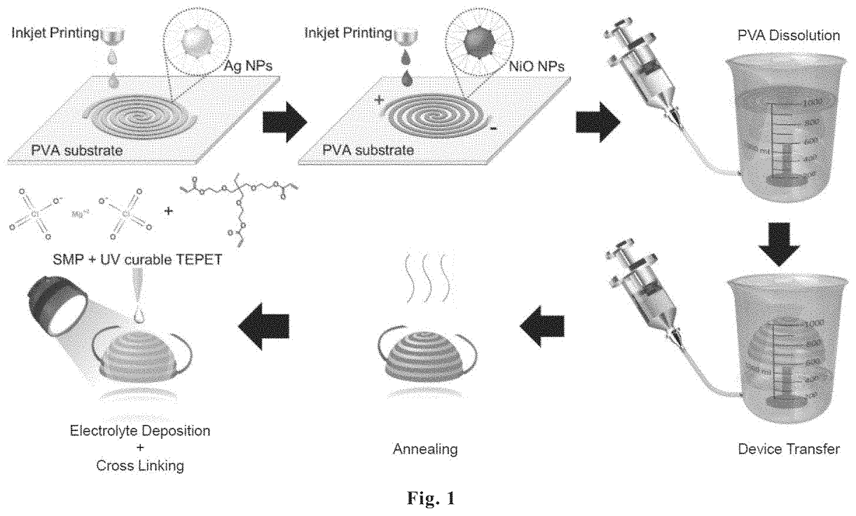

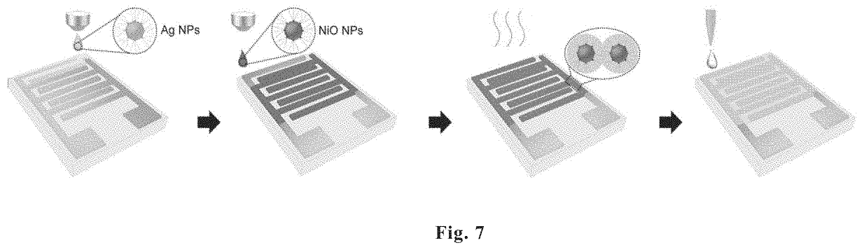

As shown in FIG. 1 and FIG. 7, the fabrication process comprises four steps: First, silver nanoparticle ink (PV Nanocell, 140TM119) is inkjet-printed on a flexible substrate to pattern the current collector of the device. NiO nanoparticle ink is inkjet printed on top of the interdigitated fingers of the silver current collector while unsintered, to form the active electrode layer of the device. A time delay is added between the printing layers to ensure that the solvent from the ink is evaporated and each subsequent layer is printed on a dry/semi-dry surface. This way, the sintering of the device was minimized into a single step of 150° C. overnight. Finally, the electrolyte is drop cast on top of the active electrode area to assemble the full device.

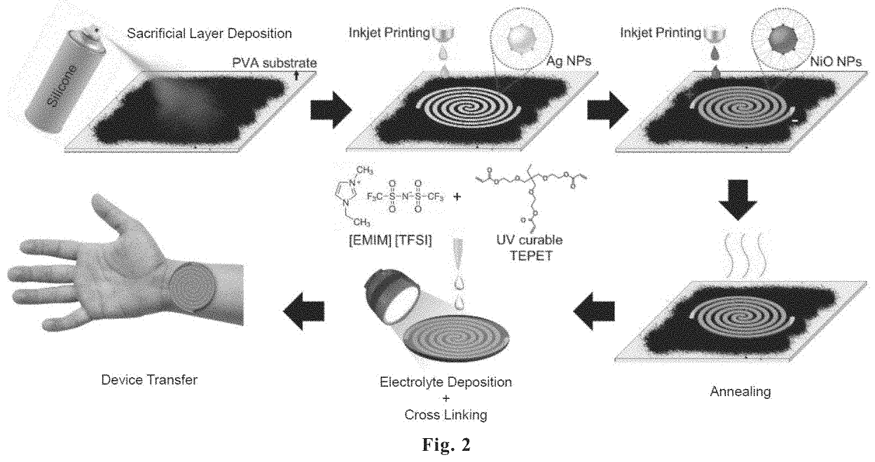

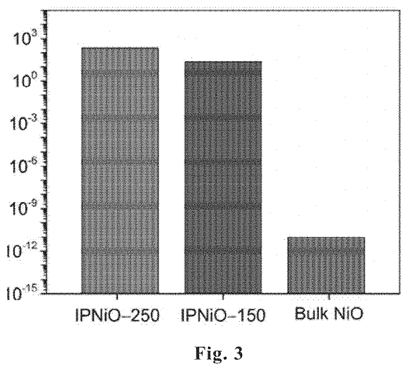

For a mass production approach, a syringe dispenser can alternatively be used to deposit the electrolyte over the desired area, as no great precision is required in this step. For the printing process, a Dimatix Materials (DMP 2800) Drop-On-Demand piezoelectric printer (Dimatix™-Fujifilm Inc.) was used with 10 pl cartridges (DMC-11610). FIG. 2 demonstrates a process for obtaining a wearable product.

### Materials Development and Characterization

More than twenty electrolyte combinations based on LiOH, KOH, NaOH, KCl, NaNO₃, NaClO₄, Mg(ClO₄)₂ and poly(4-styrenesulfonic acid) were tested with the printed NiO electrodes. The best results, in terms of capacitance and high scan rate retention, were obtained with Mg(ClO₄)₂. As a final electrolyte combination, a saturated magnesium perchlorate aqueous solution (SMPAS) was mixed with polyvinyl alcohol (PVA), ethylene glycol and Kodak Photo-Flo 200 wetting agent. The realized solution was a clear, moderately viscous (ca. 28 cP) and slightly acidic (pH 5.6) aqueous gel electrolyte with low surface tension (ca. 22° contact angle); herein referred to as SMPG-EGS. It is believed that the added surfactant, apart from lowering the surface tension of the electrolyte enhancing wettability, forms ion paths that facilitate greater ion mobility and further extends the voltage window of the electrolyte due to formation of a thin film on the electrodes that suppresses gas evolution.

A NiO ink was developed by dispersing NiO nanoparticles (<50 nm particle size) in ethylene glycol with the help of a non-ionic surfactant (C₁₄H₂₂O(C₂H₄O)ₙ where n is 9.5, marketed under the trade name TRITON® X-100).

As part of the development process of the ink, a variety of surfactants were used to disperse the NiO nanoparticles in ethylene glycol, such as sodium dodecyl sulfate (SDS), sodium dodecylbenzene sulfonate (SDBS) and polyoxyethylene(2) cetyl ether (Brij® 52). Ethylene glycol—NiO nanoparticles (12 w/w %) ink formulations with SDS, SDBS, Triton® X-100, Triton® X-405, Brij 52 and Brij 58 surfactants the day of preparation, the day after and ten days after.

The weight fraction ratio of NiO to surfactant was 1:1 in all cases. The solutions showed stable mixing in the first day. In the second day, the solution with SDBS showed clear sedimentation of the nanoparticles. The Triton® X-100 and Triton® X-405 remained stable in liquid form with zero sedimentation. The ink with SDS formed surfactant clusters and the inks with Brij 52 and Brij 58 formed a paste-like solution. After ten days, the ink with SDS surfactant showed complete sedimentation with the solvent transformed into a wax-like form. The inks with Brij 52 and Brij 58 kept the nanoparticles dispersed but the dispersion turned into a very thick paste instead. The Triton® X-405 remained stable liquid with almost no sedimentation at all. However, few clusters with agglomerated nanoparticles were observed at the surface of the dispersion. The ink solution with Triton® X-100 showed excellent stability with no sedimentation and clusters formation. TRITON® X-100 formed the most homogeneous solution with excellent dispersion stability even after 3 months storage.

Scanning electron microscopy (SEM) imaging of the printed electrodes revealed a highly porous active electrode network with 160 nm peaks, 130 nm valleys and 44.8 nm average roughness estimated from atomic force microscopy (AFM) characterization of the film's surface.

Makhlouf et al. showed that the electrical conductivity of NiO can be increased by orders of magnitude when prepared in the form of thin films or consolidated particles and the conductivity further increases by decreasing the oxide particle size into the nanometre range (the authors reported conductivity up to 10⁻² S m⁻¹ at room temperature in their study). This phenomenon was ascribed to the significantly more efficient surface versus bulk charge transport, originating from high density surface defect states and band-like conduction due to large polarons in the 2p band of 02. In this work, the inkjet-printed NiO films showed high electrical conductivity up to 210 S m⁻¹. Similarly, the electrical conduction is mainly attributed to the hopping of holes associated with large number of Ni₂⁺ vacancies on the surface of the particles.

In Makhlouf et al., the measured samples were prepared by calcinating (at 350° C.) and pressing NiO powder in dense pellets (ca.1 mm thick), which led to a material with well fused particles, less grain boundaries and consequently less Ni₂⁺ vacancies. In this work, the inkjet printed NiO nanoparticles have not been exposed to any compression or calcination above 350° C., leading to a material with more grain boundaries, more particle surface area and more Ni₂⁺ vacancies, hence, higher electrical conductivity compared to the reported values of Makhlouf s et al. work.

To investigate the effect of surfactant in IPNiO films, X-ray photoelectron spectroscopy (XPS) was conducted for two films: one annealed at 150° C. (IPNiO-150) and the other at 250° C. (IPNiO-250), both for 8 h. The survey XPS spectra of the samples showed that high intensity Ni 2p and O 1s peaks are observed for the IPNiO-250 surface while the Ni 2p and O 1s peaks are much less intense for IPNiO-150, attributed to the accumulation of carbon, originating from partially undecomposed surfactant: For IPNiO-250, the Ni 2p_{3/2} peak has a binding energy of 853.65 eV indicating that Ni is in the +2 oxidation state. Multiplet splitting between the IPNiO-250 Ni 2p_{3/2} (853.65 eV) and Ni 2p_{1/2} (871.25 eV) peaks is 17.6 eV is consistent with reported data in the literature.

The electrical conductivity of IPNiO-150 is about one order of magnitude lower than IPNiO-250 due to the carbon residues in the film. However, the samples with the remaining carbon showed greater robustness and structural integrity in the films which helped to retain the performance of the devices under bending deformation.

### Electrochemical Characterization

To evaluate the performance of the IPNiO MSCs, cyclic voltammetry (CV), galvanostatic charge—discharge (GCD) and electrochemical impedance spectroscopy (EIS) were performed. Pseudocapacitors usually operate at rates below electric double-layer capacitors (EDLCs) with only few exceptions reported.

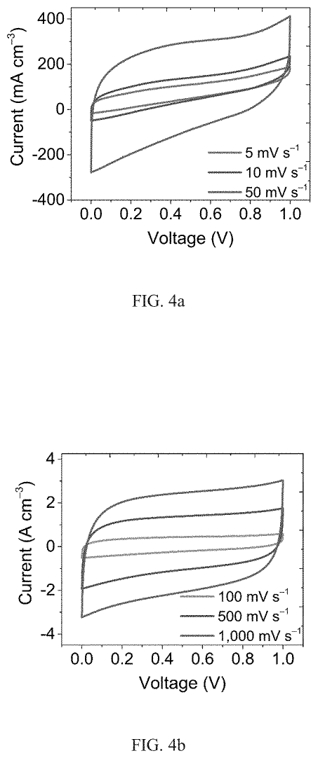

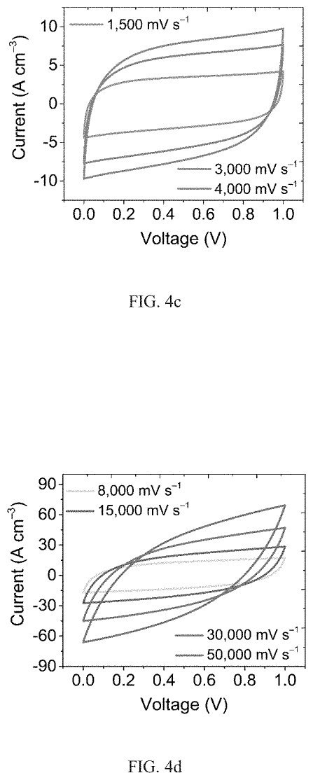

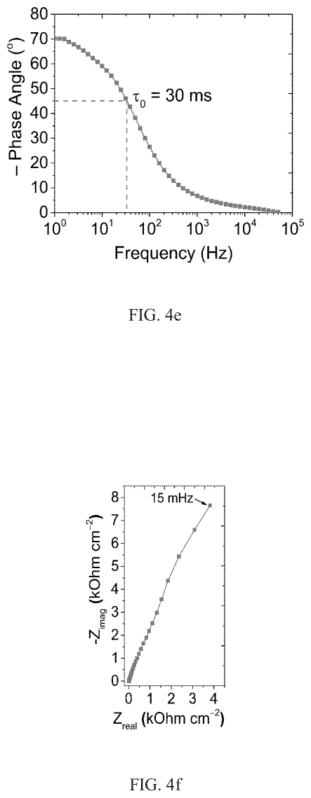

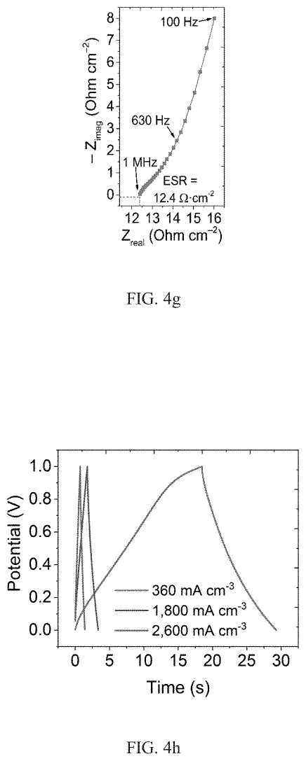

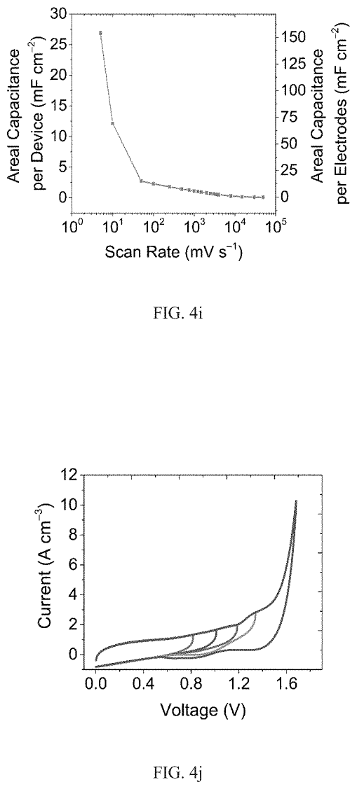

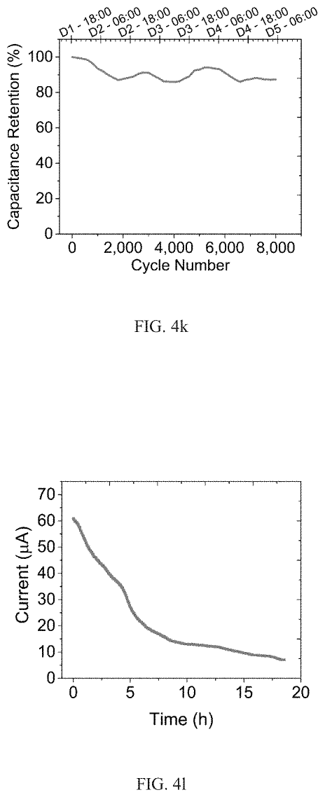

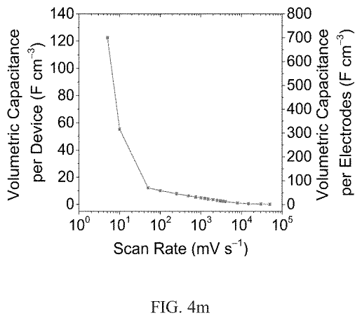

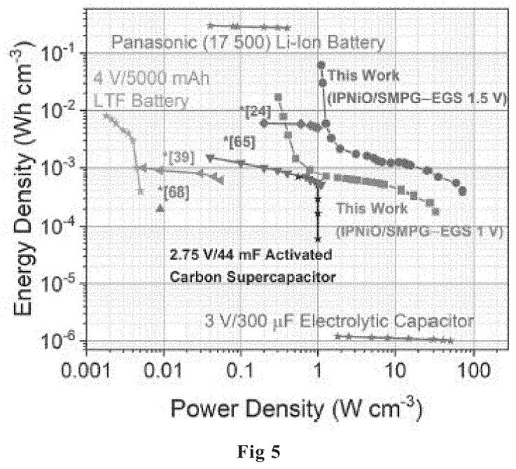

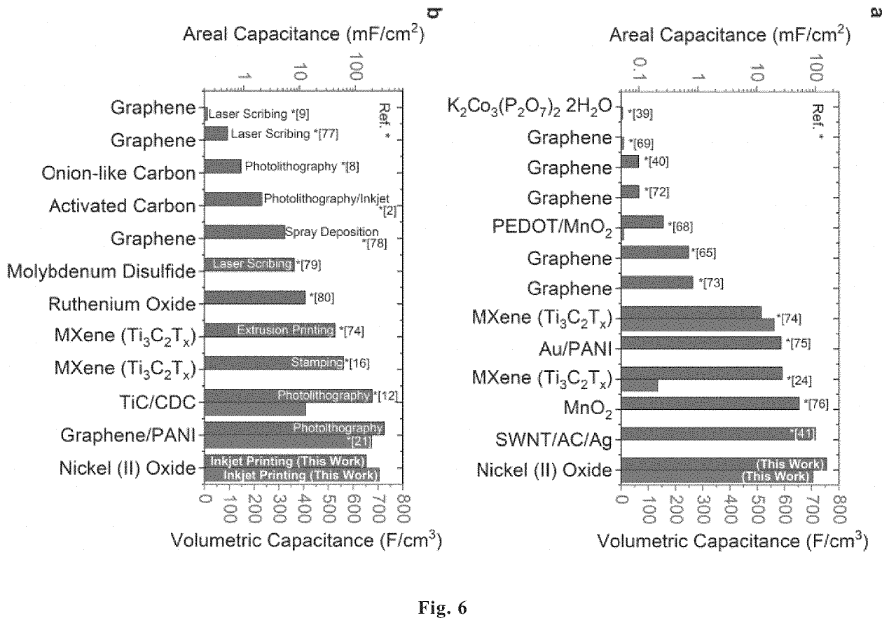

In the CV experiments of this work, the IPNiO MSCs were tested from 5 mV s⁻¹ up to an ultra-high scan rate of 50000 mV s⁻¹. As shown in FIG. 4a-d, the IPNiO-150 devices exhibited a nearly rectangular CV response, even at high scan rate of 30000 mV s⁻¹. The IPNiO-250 devices showed even higher-rate performance with a nearly rectangular CV shape at as high as 50000 mV s⁻¹. In a number of devices, small redox peaks appeared in the CV curves due to reversible formation of Ni₂⁺/Ni₃⁺, but without otherwise distorting the overall rectangular response of the device. This response shows that the realized IPNiO electrodes exhibit minimal phase transformation and have short ion diffusion paths, which together lead to performance characteristics close to true pseudocapacitive materials such as RuO₂ and MnO₂.

The higher scan rate retention for IPNiO-250 MSCs is attributed to the surfactant residue-free electrodes, which led to conductivity higher by one order of magnitude relative to IPNiO-150. However, IPNiO-150 MSCs show higher capacitance which lead us to the conclusion that the remaining surfactant in the electrodes further enhances the energy storage performance of the device.

The areal and volumetric capacitance may be more reliable performance metrics for MSCs, as the mass loading is minimal in these devices and the gravimetric metrics can be often misleading. The areal capacitance, CAD (per device footprint area including inter-finger gaps), and areal specific capacitance, CAE (per electrodes without inter-finger gaps) of IPNiO-150 MSCs are presented as a function of scan rate in FIG. 4i.

Similarly, the volumetric capacitance, VAD and volumetric specific capacitance, VAE are presented in FIG. 4m. As shown in both figures, the devices exhibit remarkable areal and volumetric specific capacitances of 155 mF cm⁻² and 705 F cm⁻³ at 5 mV s⁻¹ respectively. The capacitance drops progressively up to 50 mV s⁻¹ after which it starts to stabilise at higher rates. This drop is attributed to kinetic limitations of electrochemical activities deeper in the NiO material due to sluggish electrolyte ions permeation.

The corresponding areal and volumetric capacitances at 5 mV s⁻¹ are 27 mF cm⁻² and 124 F cm⁻³ respectively. The dependence of the phase angle on the frequency is presented in FIG. 4e. The characteristic frequency, f₀ at a phase angle of −45°, is ca. 33.4 Hz, corresponding to a time constant, τ₀ (the minimum time is needed for a device to discharge all of its energy with an efficiency of greater than 50%, calculated as 1/f₀) of just 30 ms, outperforming other pseudocapacitive devices based on MnO₂/CNTs (150 ms), onion-like carbon/MnO₂ (40 ms) and nanostructured cobalt ferrite (174 ms).

This time constant may be the lowest reported to date for any pseudocapacitive electrode and compares well with ultra-high power EDLC supercapacitors based on light-scribed graphene (19 ms), onion-like carbon (26 ms) and graphene/CNT composite (4.8 ms).

Furthermore, impedance spectra of IPNiO MSCs (FIGS. 4f and g), show pure capacitive behaviour even at the high frequency range, due to the highly accessible surface of the NiO nanoparticles. The equivalent series resistance (ESR) obtained from the intercept of the plot on the real axis is 12.4 ohm cm⁻², which is attributed to electrolyte resistance caused by the crystallization of Mg(ClO₄)₂ salt due to joule or ohmic heating that affected the stability of water content in the electrolyte.

For devices with current collectors, a semicircle is often observed in the high frequency range of the complex-plane plot, caused by an RC element in the system due to imperfections in the electrical contact between the current collector and the active electrode material. The absence of this semicircle for IPNiO MSCs indicates that the technique of printing the NiO layers on top of the unsintered current collector followed by a single annealing step, is successful in providing smooth transition with excellent contact at the interface of the two materials. In addition, the absence of the semicircle indicates that the ionic charge transfer and electron charge transfer resistances within the NiO electrodes are low. The superior rate handling ability of IPNiO MSCs was further confirmed by GCD tests (FIG. 4h). The curves show nearly ideal triangular shape even at an ultrahigh current density of 2.6 A cm⁻³. The iR voltage drop is barely discernible at high discharge currents and 21 mV at 360 mA cm⁻³. The device showed low leakage current (FIG. 4l) of 6 mA, well comparable to commercial supercapacitors (2.75 V/44 mF with 10 mA leakage current after 12 h). The cycling performance of IPNiO MSCs was examined up to 8000 cycles at a scan rate of 50 mV s⁻¹ (FIG. 4k).

94% of the initial capacitance was recovered after ca. 5300 cycles revealing that the IPNiO MSCs do not suffer from the typical degradation of microstructure as most NiO-based supercapacitors. The ability of SMPG-EGS electrolyte to operate over a wider potential window was studied through a CV test of the devices that was performed at 50 mV s⁻¹ with a lower voltage limit of 0.0 V and a higher voltage limit of 0.8-1.7 V (FIG. 4j). The device showed the typical rectangular response with a higher voltage limit of up to ca. 1.5 V, without signs of gas evolution. Above 1.5 V the electrolyte became unstable and visible gas bubbles were formed and trapped inside the gel. For examples of alternative supercapacitors, see Adv. Funct. Mater., 2018, 28, 1705506 and Energy Environ. Sci., 2016, 9, 2847.

### Design Flexibility and Integration

In many practical applications, the total energy and maximum voltage that an MSC can deliver is not sufficient and consequently, the devices have to be connected in parallel and/or series configuration to meet the energy and power requirements of the application. With IPNiO MSCs, the connections can be integrated as part of the device fabrication itself, reducing the post processing steps required for an interconnected module. The connections are produced in the first step with the printing of the MSC's current collector, keeping the fabrication confined in 4 steps and producing an ‘all-in-one’ integrated system.

The digital nature of inkjet-printing enabled the fabrication of multifunctional energy storage units, including a device that served as the energy storage that was able to power an LED. Five cells in total were seamlessly connected in series configuration to form a supercapacitor that is able to deliver up to 7.5 V.

The solution processed nature of inkjet printing was utilized to create nanostructured thin film NiO electrodes that showed high electrical conductivity up to 210 S m⁻¹. The enhanced conductivity was reflected in the relaxation time constant of the devices with just 30 ms. The IPNiO MSCs showed remarkable maximum areal and volumetric specific capacitances of 155 mF cm⁻² and 705 F cm⁻³ respectively, without compromising the high-rate ability of the devices.

A Ragone plot is provided in FIG. 5 that compares the performance of IPNiO MSCs operated at 1.0 and 1.5 V to different commercial energy storage devices and state-of-the-art inkjet-printed supercapacitors designed for high-energy and high-power electronic applications. As shown, the IPNiO MSCs exhibit superior energy density at low rates, approaching Li-Ion batteries performance, and superior power density well comparable to electrolytic capacitors. To the best of our knowledge, the realized devices showed the highest performance among the reported inkjet-printed supercapacitors but also surpassed a few of the best microsupercapacitors known to date.

In the foregoing specification, the invention has been described with reference to specific embodiments thereof. While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. An ink composition comprising NiO nanoparticles dispersed in a liquid medium, wherein the liquid medium comprises a first solvent that has a boiling point of 150° C. or more, the boiling point being measured at a pressure of 100 kPa.

2. The ink composition of claim 1, wherein the liquid medium further comprises a second solvent, the second solvent having a boiling point of 100° C. or less, the boiling point being measured at a pressure of 100 kPa.

3. The ink composition of claim 1, wherein the NiO nanoparticles constitute at least 20 w/w % of the composition.

4. The ink composition of claim 3, wherein the NiO nanoparticles constitute (i) 20 to 40 w/w % of the composition; or (ii) 60 to 80 w/w % of the composition.

5. The ink composition of claim 2, wherein the first solvent has a boiling point of 300° C. or less; and/or the second solvent has a boiling point of 95° C. or less.

6. The ink composition of claim 1, wherein the first solvent is selected from ethylene glycol, diethylene glycol, methylene glycol, propylene glycol, ethylene glycol monobutyl ether, 2-Ethoxyethyl acetate, furan-2-carbaldehyde, propane-1,2,3-triol, butane-1,2,4-triol, 1-hexanol, cyclohexanol, 2-aminoethanol, ethyl acetoacetate, 1-octanol, and/or benzyl alcohol.

7. The ink composition of claim 2, wherein the first solvent is selected from methylene glycol, ethylene glycol, propylene glycol, and/or diethylene glycol.

8. The ink composition of claim 2, wherein the second solvent is selected from a monohydric alcohol, a ketone, tetrahydrofuran, a carboxylate ester (e.g. methyl acetate or ethyl acetate), acetonitrile, and/or dimethoxyethane (glyme).

9. The ink composition of claim 2, wherein the second solvent is selected from methanol, ethanol, 1-propanol and/or 2-propanol.

10. The ink composition of claim 2, wherein the liquid medium comprises 50 to 100 v/v % first solvent and 0 to 50 v/v % second solvent.

11. The ink composition of claim 10, wherein the liquid medium comprises 60 to 90 v/v % first solvent and 10 to 40 v/v % second solvent.

12. The ink composition of claim 2, which comprises 20-40 w/w % NiO nanoparticles, 20-40 w/w % first solvent, 5 to 15 w/w % second solvent and optionally a surfactant.

13. A process for printing an ink composition, the process comprising
depositing an ink composition onto a substrate, the ink composition comprising NiO nanoparticles dispersed in a liquid medium; and
removing at least a portion of the liquid medium from the substrate to provide a printed substrate having printed material thereon,
wherein the liquid medium comprises a first solvent, the first solvent having a boiling point of 150° C. or more.

14. The process of claim 13, wherein the liquid medium additionally comprises a second solvent, the second solvent having a boiling point of 100° C. or less, the boiling point being measured at a pressure of 100 kPa.

15. The process of claim 13, wherein depositing comprises inkjet printing, aerosol jet printing, screen-printing, spray-coating, doctor blading, spin-coating or stamping.

16. The process of claim 13, wherein the substrate is flexible, stretchable and/or wearable.

17. The process of claim 13, wherein depositing comprises inkjet printing and the process is employed to produce printed electronics.

18. The process of claim 17, which comprises fabrication of a supercapacitor component by:
inkjet printing of a current collector;
inkjet printing NiO electrodes onto the current collector;
thermally sintering the current collector and the NiO electrodes together; and
dropcasting an electrolyte.

19. A supercapacitor component produced by the process of claim 18.
